(19) United States
(12) Patent Application Publication
(10) Pub. No.: US 2026/0358834 A1
(43) Pub. Date: Nov. 12, 2026

(54) METHOD AND SYSTEM FOR TRANSPORTING ITEMS

(71) Applicant: FIVES INTRALOGISTICS SAS, Chasse-Sur-Rhöne (FR)

(72) Inventor: Oussama CHERIF IDRISSI EL GANOUNI, PARIS (FR)

(21) Appl. No.: 19/103,118

(22) PCT Filed: Aug. 10, 2023
(86) PCT No.: PCT/EP2023/072245

§ 371 Date: Feb. 11, 2025

(30) Foreign Application Priority Data
Aug. 12, 2022 (FR) FR2208289

(51) Int. Cl. G05D 1/695; G05D 1/65; G05D 105/28

(52) U.S. Cl. CPC G05D 1/695; G05D 1/65; G05D 2105/28

(57) ABSTRACT

The invention relates to a method for transporting items in an intralogistics system using autonomous mobile robots each capable of transporting one item in a transport circuit of said system, the method comprising a step of forming a convoy comprising at least two mobile robots traveling at the same speed at least along one section of the circuit.

The invention also relates to a system for carrying out the method, as well as to a facility for sorting items comprising such a system.

### TECHNICAL FIELD OF THE INVENTION

The invention relates to the field of intralogistics and concerns a system and method for transporting objects using autonomous mobile robots (or automatically guided vehicles), each capable of moving at least one item.

Such a transport system can be used, for example, in a sorting facility or in an automatic storage system.

### STATE OF THE ART

Many applications such as those described above use autonomous mobile robots (AMRs) or automatically guided vehicles (AGVs) to transport objects to be sorted or stored in an intralogistics facility. The large number of such robots/vehicles circulating at the same time in the circuit generates a risk of collisions between robots/vehicles, and means that their movements need to be managed with this factor in mind. Generally speaking, the risk of collisions is limited by using circuits without crossings, or by implementing priority rules to manage the order of passage of AMRs/AGVs at crossings. These rules may be satisfactory in certain cases where the work rate is low, but they are generally not sufficient when the tasks to be carried out require a high work rate, either for sorting items, storing them, or taking them out of stock to prepare orders.

Moreover, known systems only resolve certain situations by slowing the pace. For example, when two robots/vehicles follow one another in the same traffic lane, the slightest bifurcation of the first robot causes the following robot to slow down or stop to avoid a collision. The repetition of such slowdowns and/or stoppages inevitably reduces the work rate of the robots/vehicles, and therefore of the entire system.

The aim of the present invention is to propose a new solution for increasing the work rate of AMRs/AGVs on an intralogistics circuit while limiting the risk of collisions.

### SUMMARY OF THE INVENTION

To this end, the invention relates to a method for transporting items in an intralogistics system using autonomous mobile robots or automatically guided vehicles, each capable of transporting one item in a transport circuit of said system, the method comprising a step of forming a convoy comprising at least two robots/vehicles traveling at the same speed at least along one section of said transport circuit.

By forming a convoy, it becomes possible to reduce the average distance between autonomous mobile robots or automatically guided vehicles, thereby increasing throughput.

A convoy is a set of autonomous mobile robots (or AGVs) moving along a single track or along parallel tracks in close proximity (according to defined separation distances) and at substantially the same speed.

“Substantially the same speed” means that AMRs/AGVs in the same convoy may, for example, have the same speed on straight sections of the circuit and may have an identical speed profile on bends to change direction, their speeds remaining very close along the route.

Advantageously, said convoy formation step is performed in a so-called introduction section and comprises defining a grid of theoretical positions, each of which can be occupied by an autonomous mobile robot, said grid comprising a plurality of parallel tracks and a plurality of successive parallel rows crossing said tracks and forming an angle different from zero with the tracks, the convoy comprising two or more robots of different rows positioned in such a way that two robots of successive rows of the same track are spaced apart by a predetermined minimum distance.

Using such a grid of theoretical positions, it is possible to generate different possible arrangements of AMRs (or AGVs) to form a convoy. Such positions can comprise convoys with single-track robots or robots from different tracks. A convoy is formed in the introduction section of the circuit. Robots arriving in this section, which may have different speeds, are organized in this area by adapting their speeds and/or changing their positions so as to place them on one or more tracks and with rows corresponding to the rows of the theoretical grid. Once a convoy has been formed, the mobile robots (or AGVs) move together at substantially the same speed. Optionally, it may be possible to select the best configuration by comparing possible configurations. This configuration can be chosen to allow smoother movement of the AMRs.

The minimum distance avoids collisions between mobile robots on the same track along the route.

Advantageously, the convoy formation step comprises a sub-step wherein two theoretical grid positions having the same row and belonging to two adjacent tracks are offset in the longitudinal direction of the introduction section by a distance equal to the distance between said two adjacent tracks (in the transverse direction).

Advantageously, the rows in the introduction section form an angle of +45° or −45° with the tracks, corresponding respectively to a positive or negative orientation of the convoy.

Advantageously, a distribution section connected to the introduction section is added to the transport circuit, said distribution section having one or more parallel robot entry tracks intersecting several parallel robot exit tracks, said exit tracks forming, with the robot entry tracks, a deviation angle different from zero; the method further comprises a step of moving the robots of said convoy between said entry tracks and said exit tracks with substantially the same speed.

Advantageously, the deviation angle defines a positive or negative orientation of the distribution section. If the angle is negative (positive), the distribution section is considered to be oriented negatively (positively).

The number of entry tracks can be equal to the number of tracks in the introduction area.

Since the distribution section is formed by one or more entry tracks crossing exit tracks, at each crossing an AMR/AGV can change direction, thus all the exits are accessible from any entry. This allows the best route to be chosen, and as a result allows throughput to be improved by multiplying the possible routes.

Additionally, when the distribution section is crossed by a convoy with the right configuration (orientation and distance between vehicles), there will be no collisions between vehicles, irrespective of the exit selected. In particular, this is made possible by maintaining a minimum distance between robots on the same track, and by longitudinally offsetting ranges belonging to parallel tracks.

Advantageously, the robots can be controlled so as to group together in a configuration forming a convoy at the exit of the distribution section.

Advantageously, an additional distribution section is added to the circuit, having one or more parallel second robot entry tracks intersecting one or more parallel second robot exit tracks, said second exit tracks forming, with the second robot entry tracks, a deviation angle different from zero and, optionally, of opposite orientation to the angle of the distribution section; the method further comprises a step of moving the convoy between said second entry tracks and at least one of said second exit tracks at substantially the same speed. This increases the number of possible routes and avoids collisions, making the movement of AMRs/AGVs more fluid.

Advantageously, the deviation angle defines a positive or negative orientation of the distribution section. If the angle is negative (positive), the distribution section is considered to be negative (positive).

This multiplies the number of possibilities for an AMR/AGV to change direction without risk of collision.

Advantageously, the distribution section and/or additional distribution sections can be one-way, to reduce the risk of collisions.

According to embodiment examples, the deviation angle of the distribution section and/or an additional distribution section is −90° or 90°.

When two distribution sections are arranged in succession, the orientation of the second distribution section may depend on the orientation of the first distribution section. For example, if the distribution section is positively oriented (the deviation angle is positive), the second will be negatively oriented.

The orientation of the convoy in the introduction section may depend on the orientation of the distribution section. For example, if the distribution section is positively oriented, then the convoy will also be positively oriented.

Advantageously, the method can comprise a step for changing the orientation of the convoy by accelerating and/or decelerating the autonomous mobile robots in a reorientation area provided between two successive distribution sections.

According to one embodiment, the distance between two tracks a=L+d, where L is the length of the robot. In this advantageous embodiment, when the parallel connecting tracks between two successive distribution sections are L+d apart (L being the length of a vehicle and d the distance between two vehicles in a convoy), there is no need to change the orientation of the convoy to avoid collisions.

In some example embodiments, the convoy comprises at least two autonomous mobile robots on the same track.

According to example embodiments, when a first robot followed by a second robot in the same convoy on the same entry track takes a first exit track, then the second robot takes a second exit track located before the first exit track.

This avoids collisions between robots/vehicles on the same track and in the same convoy.

For example, when a first robot of a first row and a second robot of a following row of the same convoy arrive via two parallel entry tracks and are meant to use the same exit track, the first robot arriving via a first entry track, the second robot then arrives via a second entry track further away from an exit end of said exit track.

This prevents collisions between successive parallel robots/vehicles in the same convoy.

Advantageously, a convoy is spaced apart from a preceding convoy by a predetermined safety distance D. This avoids collisions between mobile robots of two successive convoys in the distribution sections.

The invention also relates to a computer program comprising instructions for carrying out the steps of the method described above.

The invention also relates to a computer-readable medium comprising the computer program described above.

The invention also relates to an intralogistics transport system comprising:
a plurality of autonomous mobile robots, each capable of transporting one object,
a ground transport circuit where mobile robots can circulate,
a computer program as described above.

Said system is configured to carry out the method as described above.

The invention further relates to an item sorting facility comprising a sorting area and a transport system as described above.

The invention also relates to an automatic item storage facility, comprising an item storage area having a plurality of storage levels and raising and lowering means connecting said levels; said facility further comprises a transport system as described above.

### BRIEF DESCRIPTION OF THE FIGURES

Further features and advantages of the invention will become apparent from the following description in relation to the appended drawings, given as non-limiting examples, wherein:

FIG. 1 schematically shows a transport circuit with robots forming convoys;

FIG. 2 schematically shows an introduction section;

FIG. 3 shows an example of a distribution section connected to the introduction section;

FIG. 4 shows two successive distribution sections;

FIG. 5 shows a reorientation area;

FIG. 6 shows an example of a sorting facility carrying out the method according to the invention.

In the rest of the description, elements with identical structures or similar functions will be referred to by the same references.

### DETAILED DESCRIPTION

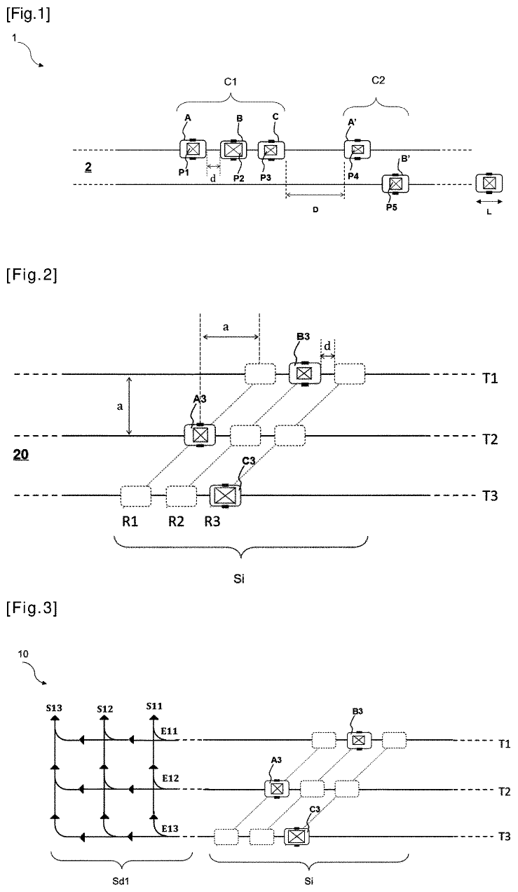

FIG. 1 is a partial schematic view of an intralogistics transport system 1. The system 1 comprises a transport circuit 2, shown in part, and a set of autonomous mobile robots (AMRs) or AGVs referenced A1, B1, C1, A2, B2. For the sake of simplicity, reference will be made only to AMRs in the following description, bearing in mind that they can also be AGVs or other similar means of transport, sometimes called shuttles or carts in the intralogistics field.

The system also comprises control means, not shown. Such means may comprise central control means communicating with local control means arranged in each AMR. The control means comprise one or more computer control programs.

The circuit 2 comprises, for example, 2 parallel tracks as shown in FIG. 1. The robots A1, B1 and C1 circulating successively on the same track form a first convoy C1, where the robots A1, B1, C1 circulate at the same speed and each robot is spaced apart from the next by a safety distance d. This distance d is determined to avoid collisions between each robot and the next robot in the same convoy running on the same track.

The AMRs A′ and B′ travel on two parallel tracks at the same speed, forming a second convoy C2. C1 and C2 are spaced apart by a safety distance D determined to avoid collisions between the AMRs of C1 and C2 in the distribution sections that will be described later.

The minimum number of AMRs required to form a convoy is 2, and is determined by applying the convoy principle.

In FIG. 1, these AMRs transport items P1, P2, P3, P4, P5; however, this is not necessary, since AMRs can form a convoy without being loaded, for example after depositing items in a warehouse.

FIG. 2 schematically shows an example of an introduction section according to the invention. Such a section is a portion of the transport circuit 20 where at least one convoy is formed. A transport circuit may have one or more introduction sections.

As shown in FIG. 2, an introduction section can comprise one or more tracks T1, T2, T3. In the example, there are 3 tracks, but the number can be different.

To create a convoy in the introduction section, a grid of theoretical positions is defined, shown as dotted lines in FIG. 2. The grid comprises tracks T1, T2, T3 of the circuit 20 and several parallel rows R1, R2, R3 crossing the tracks T1, T2, T3. Each crossing point shows a theoretical position that an AMR/AGV can theoretically occupy. The minimum number of rows in a convoy is 2.

To define a convoy, each row R1, R2, R3 is occupied only once, regardless of the track. It is therefore possible to have a convoy with robots on the same track like C1 in FIG. 1; it is also possible to have multi-track convoys like in FIG. 2 and like C2 in FIG. 1.

Advantageously, each two theoretical positions on the same track are spaced apart by a predetermined safety distance d.

As a result, two successive robots in the same convoy running on the same track can also be spaced apart by the same distance.

Additionally, two theoretical positions of the same row, e.g. R1, located on two adjacent tracks, e.g. T1, T2, can advantageously be offset by a distance a equal to the distance between T1 and T2.

Furthermore, the offset of the positions and the crossing of the rows with the tracks form a positive or negative angle, e.g. +45° or −45°. For example, in FIG. 2, the orientation is negative. As a result, the convoy formed by AMRs A3, B3, C3 is negatively oriented.

FIG. 3 shows an example of a transport system 10 with an entry section Si identical to that shown in FIG. 2. The system 10 further comprises a distribution section Sd1. The section Sd1 is formed in the example by 3 AMR entry tracks E11, E12, E13 in the extension of the tracks T1, T2, T3 of the introduction section. It also comprises exit tracks S11, S12, S13 that cross the entry tracks. In the example, the deviation angle formed is +90°. In other examples, the angle may be different. A robot arriving at an entry E11, E12, E13 can go straight ahead into a crossing or turn to take a nearby exit S11, S12, S13. In this way, each AMR or AGV can take any of the exits S11, S12, S13. Owing to the minimum distance d and the longitudinal offset between positions on the same range belonging to two parallel tracks, the risk of collisions is avoided as the AMRs/AGVs in the convoy travel at substantially the same speed.

Optionally, to further guarantee collision-free travel, when a first robot followed by a second robot in the same convoy on the same entry track takes a first exit track, then the second robot is required to take a second exit track located before the first exit track.

For example, when two successive AMRs of a convoy arrive at track E11, the first takes exit S13, and the second is required to take one of exits S12 or S11.

Advantageously, when a robot of a first row and a robot of a following row of the same convoy arrive via two parallel entry tracks and are meant to use the same exit track, the robot arriving via a first entry track, the second robot then arrives via a second entry track further away from an exit end of said exit track.

For Example, AMRs A3 and C3 can use the same exit without collision.

Advantageously, the entry and exit tracks can have the same length. Additionally, at crossings, the optional radii of curvature are identical along the tracks in the direction of flow. Advantageously, the distribution section can be monodirectional. This further guarantees collision-free traffic.

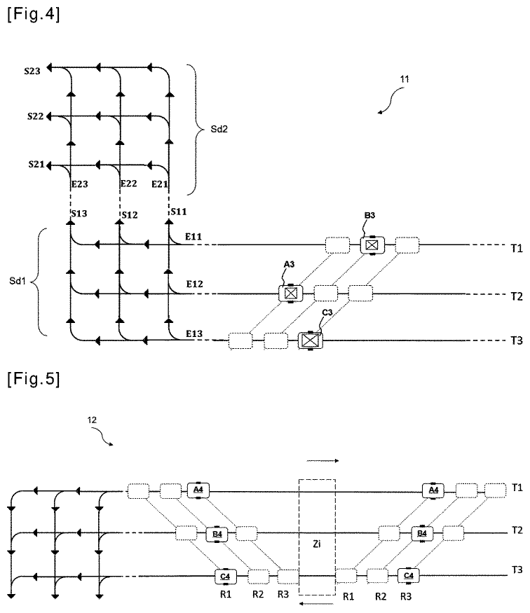

FIG. 4 shows another embodiment wherein the transport circuit 11 comprises, in addition to the distribution section Sd1 described above, a second successive distribution section Sd2 which may be identical to or different from Sd1, but in orientation is adapted to the arrangement of the exits of Sd1. In addition, the same rules described above for Sd1 can be applied to Sd2.

FIG. 5 shows another example of a transport system 12 comprising a reorientation area Zi between two distribution sections.

In the example, the AMRs A4, B4, C4 form a negatively oriented convoy, which is not compatible with the next distribution section, also negatively oriented. To adapt the orientation of the convoy, an orientation change step is carried out in area Zi by accelerating and/or decelerating the robots located on the autonomous tracks T1 and T3, so that C4 moves to the first row R1 and A4 moves to the third row R3.

In this configuration, the robots can travel without risk of collision in the distribution section, in compliance with the rules described for Sd1.

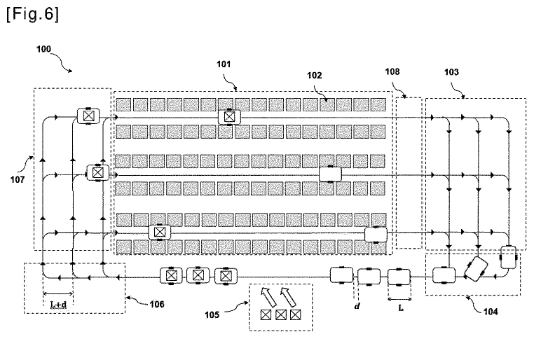

FIG. 6 shows an example of a sorting facility 100 carrying out the method according to the invention. The facility 100 comprises a sorting area 101 where chutes 102 are arranged in several lines. An area 103 is provided at the exit of the sorting area, where the AMRs/AGVs arrive after being unloaded into the chutes 102. The area 103 is a distribution section minimizing the number of vehicles required for sorting. Optionally, a reversing section 108 can be provided between the area 101 and the area 103 to correctly reorient the AMRs/AGVs leaving the sorting area 101.

At the start of the sorting method, convoys are formed in an introduction section 104, after which the convoys pass through a loading area 105, known to those skilled in the art, to receive the parcels to be sorted. The AMRs then pass through a first distribution section 106 and a second distribution section 107 opening into the sorting lines of the sorting area 101. Finally, each item is unloaded into the destination chute 102. In this example, the spacing between the tracks in area 107 and area 103 is equal to L+d, allowing the distribution sections 106 and 107 to have the same orientation without risk of collision for the AMRs/AGVs.

This application example is of course not limiting, as many other applications are possible; by way of example, the sorting system can be modified by adding additional sorting lines and distribution sections.

In one variant, the area 103 can be simplified to be an accumulation and waiting area where AMRs/AGVs accumulate after unloading into the chutes 102. In this case, the reversing section 108 is no longer required. It is also not necessary for the track spacing to be equal to L+d in the area 103.

Another application example is the use of a similar transport system, with an introduction section and distribution sections in an automatic storage facility. In addition, such a facility is known to comprise a multi-level storage area and one or more raising/lowering devices.

In this case, for example, an accumulation area can be set aside in front of each raising/lowering device, in case the device is not immediately available when an AMR/AGV arrives.

1-15. (canceled)

16. A method for transporting items in an intralogistics system using autonomous mobile robots or automatically guided vehicles, each capable of transporting one item in a transport circuit of said system, the method comprising
a step of forming a convoy comprising at least two mobile robots traveling at the same speed at least along one section of said circuit, wherein said convoy formation step is performed in a so-called introduction section and comprises defining a grid of theoretical positions, each of which can be occupied by an autonomous mobile robot,
said grid comprising a plurality of parallel tracks and a plurality of successive parallel ranks crossing said tracks and forming an angle different from zero therewith, the convoy comprising two or more robots of different ranks positioned in such a way that two robots of successive ranks of the same track are spaced apart by a predetermined minimum distance (d).

17. The method according to claim 16, wherein the convoy formation step comprises a sub-step wherein two theoretical positions of the same rank and belonging to two adjacent tracks are offset in the longitudinal direction of the introduction section by a distance equal to the distance between said two adjacent tracks.

18. The method according to claim 17, wherein the ranks in the introduction section form an angle of +45° or −45° with the tracks, corresponding respectively to a positive or negative orientation of the convoy.

19. The transport method according to claim 16, wherein a distribution section connected to the introduction section is added to the transport circuit, said distribution section having one or more parallel robot entry tracks intersecting several parallel robot exit tracks, said exit tracks forming, with the robot entry tracks, a deviation angle different from zero;
the method further comprises a step of moving the robots of said convoy between said entry tracks and said exit tracks with substantially the same speed.

20. The method according to claim 19, wherein an additional distribution section is added to the transport circuit, having one or more parallel second robot entry tracks intersecting one or more parallel second robot exit tracks, said second exit tracks forming, with the second robot entry tracks, a deviation angle different from zero and, optionally, of opposite orientation to the angle of the distribution section, the method further comprising a step of moving the convoy between said second entry tracks and at least one of said second exit tracks at substantially the same speed.

21. The method according to claim 19, comprising a step for changing the orientation of the convoy by accelerating and/or decelerating the autonomous mobile robots in a reorientation area provided between two successive distribution sections.

22. The method according to claim 19, wherein when a first robot followed by a second robot of the same convoy on the same entry track takes a first exit track, then the second robot takes a second exit track located before said first exit track.

23. The method according to claim 19, wherein when a robot of a first rank and a robot of a following rank of the same convoy arrive via two parallel entry tracks and are meant to use the same exit track, the robot arriving via a first entry track, the second robot then arrives via a second entry track further away from an exit end of said exit track.

24. The method according to claim 16, wherein the convoy is spaced apart from a following convoy by a predetermined safety distance.

25. A computer program comprising instructions for carrying out the method according to claim 16.

26. A computer-readable medium comprising a computer program according to claim 25.

27. An intralogistics transport system comprising:
a plurality of autonomous mobile robots or automatically guided vehicles, each capable of transporting one object,
a ground transport circuit where the autonomous mobile robots/automatically guided vehicles can circulate, and
a computer program,
according to claim 25.

28. A facility for sorting items comprising a sorting area and a transport system according to claim 27.

29. An automatic item storage facility, comprising an item storage area having a plurality of storage levels and raising and lowering means connecting said levels;
said facility further comprises a transport system according to claim 27.
